(19) United States
(12) Patent Application Publication
(10) Pub. No.: US 2002/0190409 A1
(43) Pub. Date: Dec. 19, 2002

(54) Method for reinforcing ceramic composites and ceramic composites including an improved reinforcement system

(76) Inventors: Charles W. Burdsall II, Huntington Beach, CA (US); Thomas E. Strasser, Corona, CA (US)

Correspondence Address: HARNESS, DICKEY & PIERCE, P.L.C., P.O. BOX 828, BLOOMFIELD HILLS, MI, 48303, US

(21) Appl. No.: 10/173,494

(22) Filed: Jun. 17, 2002

Related U.S. Application Data
(60) Provisional application No. 60/299,004, filed on Jun. 18, 2001.

(51) Int. Cl. B29C 70/28

(52) U.S. Cl. 264/29.1; 264/257; 264/258; 264/161; 264/162; 264/82

(57) ABSTRACT

An improved structural reinforcement system for ceramic composite parts fabricated with polymeric ceramic precursor resins includes a mechanically interlocked mat of carbon or graphite filaments with a semi-random orientation. The carbon or graphite mat has a density of at least about 15% filaments by volume. Using graphite mat yields finished ceramic components that exhibit substantial ductility without the use of interfacial coatings, as well as good structural strength and even distribution of thermal energy.

### CROSS-REFERENCE TO RELATED APPLICATIONS

This application is a continuation-in-part of U.S. Provisional Patent Application No. 60/299,004, filed on Jun. 18, 2002, the disclosure of which is incorporated herein by reference.

### FIELD OF THE INVENTION

This invention relates to the use of a mechanically interlocked mat of semi-random orientated filaments (felt) for structural reinforcement of ceramic composites prepared with ceramic precursor resins.

### BACKGROUND OF THE INVENTION

Ceramic composites are useful for many applications for their hardness and ability to withstand high heat. Ceramic composites are formed by first combining a fibrous reinforcement material and, optionally, a particulate filler material with a ceramic precursor matrix resin of relatively low viscosity. The resin is then polymerized, usually by heating to a moderate temperature. The polymerized state is often referred to as the “green state”. The polymer is then heated, typically to a temperature from about 600° C. to about 1200° C., and undergoes conversion to a ceramic material.

Unreinforced ceramic matrices typically used in ceramic composites have excellent compression properties but relatively poor tension and shear properties and have a marked tendency towards brittle fracture. The fibrous reinforcement material used in ceramic composites augment the composites' tension, bending, and shear properties and help prevent brittle fracture. Depending on the fiber material, fiber type, fiber orientation with respect to applied load and the ratio of fiber volume to total volume, the tension and bending capacity of a ceramic composite can easily be augmented by factors ranging from 10 to over 100. The fibers used in these systems typically are tows, also known as threads or yarns. Tows are made of bundles of filaments stranded together in a long continuous string having about 200 to 2000 individual filaments at any given cross section.

The reinforcing fibers used in ceramic composites can be made from various refractory materials that are capable of withstanding the high temperatures required to convert the ceramic precursor resins into the ceramic material. Common refractory fibers employed for this purpose are alumina silicate fibers (typified by the Nextel™ family of fibers manufactured by 3M), silicon carbide fibers (typified by Nicalon™ fibers manufactured by Nippon Industries), carbon fibers, and graphite fibers. With the exception of graphite fibers, the fibers are given an interfacial coating in order to prevent a strong bond from forming between the ceramic matrix and the fibers because such a bond is thought to extend the brittle fracture planes that form in the ceramic across the fiber, severing the fiber and causing part failure.

The fibrous structural reinforcement systems used for ceramic composites can be divided into two classes, discontinuous and continuous. In continuous fiber reinforcement systems, the tow is formed into woven mats (cloths), uniaxial tapes, windings, or knitted or braided preforms. Woven mats and cloths have a layer of interlaced tows, primarily in two, usually orthogonal, principal directions, often referred to as the warp and fill. Uniaxial tapes have a layer of tows ordered in a single direction, often held together with a binder. The use of woven mats or uniaxial tapes in a ceramic composite can greatly increase the composite's tension capacity in the directions of the tows and strength in bending about the axes perpendicular to the tow's directions. Composites utilizing woven mats and uniaxial tapes are usually laminates, i.e. made of multiple layers, often with varying tow orientations from layer to layer.

The reinforcement system orientations may be chosen such that the structural properties are roughly uniform about the surface normal, particularly for parts with a thickness that is substantially smaller than its other dimensions. Windings are normally used to maximize the circumferential structural properties, particularly tension, of cylinders or spheres. In windings, tows are coiled about a radius. Knitted or braided preforms are often used for regularly shaped three-dimensional parts.

Continuous fiber reinforcement systems all share the advantage of improving the augmented structural capacity, particularly tension and bending, for the part overall when loaded in the tow's longitudinal directions. With two-dimensional continuous reinforcement systems (mats, tapes, and windings), flat or curved, the out-of-plane, interlaminar, tension capacity is usually dominated by the comparatively weak matrix material as no fibers run longitudinally in this direction. One problem with reinforced ceramics is that, regardless of the continuous reinforcement system, the ceramic has ceramic matrix-rich local areas of various sizes where the tows either abut one another in the lay-up (windings and uniaxial tape) or cross over and under one another (cloth mats, windings and knitted preforms). From an overall part perspective, these local matrix pockets have little, if any, impact on the structural properties of the ceramic composite, but they can be susceptible to surface pitting or chipping.

Another drawback of presently used continuous reinforcement systems is that, with the exception of uniaxial tapes, they require complex machinery to order the tows in the desired manner. The machinery to knit, braid, or weave the tows can add significant cost to the manufacture of ceramic composites, particularly for composites using knitted or braided preforms. Uniaxial tapes and cloth require additional labor for part lay-ups, which also adds significant cost. In addition, the manual lay-up step is a potential source of defects in the manufacture of ceramic composites due to improper lay-up orientation of the individual plies.

It is also difficult to add filler material along with these continuous fiber reinforcement systems without introducing unacceptable structural defects into the ceramic composite articles. It would be advantageous to add filler materials to reduce overall cost or change such physical characteristics of the ceramic composite as density or heat capacitance. Continuous fiber reinforcement systems also tend to inhibit uniform heat transfer through the part thickness since most fibers transmit heat much better along their length (in general normal to the thickness direction) than across their diameter.

The second class of fiber structural reinforcement systems used for ceramic composites is discontinuous fiber reinforcement systems. Discontinuous fiber reinforcement systems include chopped yarn or chopped tows, collectively known as chopped fibers. Useful lengths for the chopped fibers typically range from about 6 mm to about 25 mm. The chopped fibers are randomly disposed throughout the ceramic composite part by a variety of methods with varying degrees of complexity. One simple method is to fill a mold with the desired amount chopped fibers, add the appropriate amount of ceramic precursor resin, apply the pressure required for the desired fiber compaction, polymerize the resin, and convert the polymer to ceramic. A more complicated method would be to slurry the chopped fibers in the resin, then inject this slurry, under pressure, into a mold, where the resin is polymerized. Random mats have lengths of fiber randomly distributed in a layer with organic binders to yield a cohesive mat. The fibers in a random mat originate and end in the same layer. Random mats are employed in the manufacture of composites much like cloth mats.

Discontinuous fiber reinforcement systems have the advantage of being able to easily conform to complex, three-dimensional shapes. Most chopped fiber systems are also relatively inexpensive compared to continuous fiber systems. The added labor needed for forming a ceramic composite made with chopped fibers is usually minimal and the processes are straightforward. Further, heat transfer throughout a ceramic composite made with chopped fiber is reasonably uniform in all directions. Finally, a filler material, if used, is much easier to disperse evenly through the ceramic when a discontinuous fiber reinforcement system is used than when a continuous fiber system is used.

Discontinuous fiber reinforcements are not without their own problems, however. Due to the random distribution of the fibers in the part and the difficulty involved in obtaining a uniform distribution of fibers, relatively large resin-rich pockets are common and resin-rich veins sometimes form. Long fibers, about 10 mm or longer, exacerbate this problem. These resin-rich pockets are usually much larger than the resin-rich pockets found in continuous fiber reinforcement systems. Resin-rich pockets weaken the part since the reinforcing fiber is missing in these areas. In general, ceramic composites reinforced with discontinuous fiber systems are significantly weaker than ceramic composites reinforced with continuous fiber systems. Further, the relatively short length of the fibers used in discontinuous systems, as compared to continuous fiber systems, tends to limit the load carrying capacity of the ceramic made with discontinuous fibers. An additional problem for discontinuous fiber reinforcement systems, especially with fibers about 10 mm or longer, is the difficulty of obtaining a useful fiber volume without crushing the fibers to a length of less than 6 mm. The fiber volume usually must be more than 15% for the composite part to have sufficient structural (tension or bending) properties but at this volume a significant portion of long fiber may be crushed during fabrication.

It would thus be desirable to use a fiber system that offers the strengths of both continuous and discontinuous fiber reinforcement systems without being impaired by the disadvantages of either.

### SUMMARY OF THE INVENTION

The present invention provides, in one aspect, a method of preparing ceramic composite by using a high-density carbon or graphite felt mat, which is a mat of mechanically interlocked filaments having a semi-random orientation. By “interlocked” it is meant that the filaments of the felt are engaged such that the relative motion between fibers is constrained. By “semi-random” it is meant that the filaments are generally randomly oriented in the felt, although they are constrained to the thickness of the felt.

The invention provides a process of preparing a high-density carbon or graphite felt mat from a rayon felt or other organic polymeric felt of fiber that can be converted to carbon or graphite. The method includes steps of wetting the organic felt mat, preferably rayon felt mat, with water, compressing the wetted rayon felt mat to the desired density of fibers, drying the compressed rayon felt mat to produce a densified organic polymeric (e.g., rayon) felt mat, and heating the densified felt mat to produce a high-density carbon or graphite felt mat. Without compression, rayon and other organic felt mats produce graphite or carbon mats of about 5 to 10% fiber volume (volume of fiber based on total volume of mat). The high-density felts produced by the invention have at least about 15% fiber volume, and, depending on how much the organic mat is compressed, can have significantly more fiber volume, at least up to about 40%.The invention provides a process that includes steps of providing one or more high-density carbon or graphite felt mats, wetting or impregnating the felt mat (or each felt mat) with a ceramic precursor material, polymerizing or curing the ceramic precursor material, and converting the polymer or cured polymer to a ceramic. The felt mats may be cut to the desired shape and layered in a stack to the desired thickness or otherwise positioned. After being wet with the ceramic precursor material, the stack of mats may be compressed sufficiently to insure intimate contact between the layers.

In another aspect of the invention, the felt mat or mats are impregnated with a higher molecular weight ceramic precursor polymer, for instance a molten polymer, allowing the precursor polymer to set, e.g. by drying or hardening through cooling, and converting the polymer to a ceramic.

The invention further provides a reinforced ceramic prepared using a high density carbon or graphite felt mat or mats. The ceramic may be formed by the methods of the invention.

The ceramic formed with a dense felt mat has a number of advantages over ceramics with other fiber reinforcements. The dense felt reinforcement produces ceramics in which structural properties in a single ply are independent of orientation, and overall structural properties approach isotropic. Heat transfer has greater uniformity, which is particularly desirable in friction applications. The dense felt reinforcement provides the ceramic with greater ductility compared to conventional reinforcement systems. The dense graphite or carbon felt mats provides the advantages of woven mats, but are less costly and do not require complex knitting, braiding, or weaving machinery.

Densifying the fibers of the fiber mat leads to additional advantageous over conventional reinforcement systems. Because the pockets of ceramic matrix are smaller and more uniformly distributed, the ceramic part avoids the problems associated with matrix-rich local areas. Additionally, the ceramic article can be machined to an extremely uniform finished surface.

When the felt mat is a graphite felt mat, in particular, no interfacial fiber coating is needed to prevent brittle fracture. Further, the dense graphite felts provide particularly good heat transfer characteristics. Graphite felts mats of a desired density, especially those having a density of at least about 40% by volume graphite fiber, are easily obtained from rayon or other polymeric organic precursor felts by compressing the precursor felt prior to carbonizing the felt according to the process of the invention.

### DETAILED DESCRIPTION OF THE INVENTION

The ceramics of the invention are prepared using an interlocked felt mat. An interlocked felt mat is made by the application of heat, moisture, chemicals, mechanical action, and/or pressure to filaments, particularly those possessing good felting properties, such as waviness or crimp. One preferred felting method includes a mechanical action, such as needling, which may be combined with other steps. In a felt mat, the fibers are interlocked, but not woven. Organic polymeric felts are available in a variety of densities and materials. The felts can also have inorganic polymeric fibers that will be converted to ceramic fibers in addition to the organic polymer fibers that are converted to carbon and graphite filaments. The felt mats have interlocked individual filaments and/or interlocked strands of a small number of filaments (generally on the order of ten or less). Consequently, the filaments used in felt mats typically have small diameters compared to the tows used in other reinforcements systems.

The felt mats are compressed to a high-density felt. When felts are compressed into dense mats, the smaller diameter of the filaments makes possible smaller, individual volumes devoid of reinforcement than typically possible in continuous fiber reinforcement systems although the felt mat may have a greater total void volume. Individual void volumes in a felt mat are more uniform in size and distribution than in discontinuous fiber systems. The organic polymeric felt (which may also include inorganic fibers) is compressed before conversion to the carbon or graphite felt.

The organic fiber felt (e.g., the rayon precursor felt) is wet, especially with water, and then compressed and dried in the compressed state. Rayon, in particular, being cellulose-based, readily absorbs water and, if compressed or shaped while moist, will retain that shape if allowed to dry in that shape. Other hydrophilic fibers such as polyesters, other cellulosics, and nylons may be used. Rayon felts are particularly preferred. Low density rayon felts can be easily densified by moistening the felt and then pressing it to the desired density and drying it while compressed. Steam pressing can also be employed to compress the rayon felt to a high density.

High-density carbon or graphite felts are then obtained from the high-density organic polymeric felt, particularly the rayon felt, through heating in a non-oxidizing atmosphere at a temperature high enough to effect the conversion to the graphite or carbon fiber. The rayon felt, commonly manufactured at a fiber density of less than 10% by volume, may be compressed to a fiber density of at least about 15% by volume, preferably at least about 30% by volume, more preferably at least about 40% by volume, still more preferably at least about 50% by volume, and yet more preferably at least about 60% by volume, and even more preferably at least about 80% by volume, with fiber density being expressed as volume percent based on total volume of the felt. The compressed felt is then heated in a non-oxidizing atmosphere to produce a densified carbon or graphite felt.

The filaments in the compressed felt mats are typically uniformly distributed throughout the mat such that the percentage of volume comprised of reinforcement is essentially constant throughout the mat. The filaments have a semi-random orientation. The individual filaments tend to originate on one surface of the mat and terminate on the opposite surface of the mat with the majority of their length generally parallel with the mat's surfaces. The filaments in the felt mat are generally wavy in shape and arbitrarily oriented with respect to each other. The orientation, from 0° to 360° with respect to a plane generally parallel to the mats surfaces, and distribution of effective lengths tends to be uniform. The through-thickness distribution of effective filament lengths tends to be uniform on a per unit area basis.

The felts of this invention differ from random mats or directed fiber preforms, which sometimes are also referred to as “felts.” Unlike random mats and directed fiber preforms, the felts of the invention are characterized by mechanical interlocking between the individual fibers. Random mats and directed fiber preforms instead rely on “binders” (usually organic) to hold together the individual fibers. Unlike fibers in the mats of the invention, the individual filaments in random mats and directed fiber preforms on the whole originate and terminate in the same plane without providing effective length through-thickness.

When the felt mat is combined with a suitable matrix material and the matrix material is converted to a ceramic, a composite having nearly isotropic structural properties is formed. Multiple felt mats when stacked in layers and combined with a suitable matrix material form a ceramic composite with orthotropic (and potentially isotropic) structural properties. Composites using the felt mat for a structural reinforcement system have superior structural properties compared to those made with a discontinuous reinforcement system utilizing fibers of the same material.

While a continuous reinforcement system like a cloth typically has superior tension properties in the aligned fiber directions compared to the felt mat reinforcement of the invention, the felt mat reinforcement has better bearing and in-plane shear properties. Preforms are sometimes made by stacking cloth mats and stitching through the layers to provide for though filaments, which enhance the interlaminar strength for the preform. Needling can be used instead of stitching to obtain the through filaments; this is sometimes referred to as “felting” the preform. These preforms can be made from organic fibers that are converted to carbon (or graphite) or from refractory fibers. The in-plane thermal conductivity using the mat of the invention has greater uniformity and through-thickness thermal conductivity is thus higher with the felt reinforcement system than with continuous and most discontinuous reinforcement systems. These properties give the densified felt-reinforced ceramic of the invention important advantages for many applications.

The carbon or graphite filaments of the felt are refractory fibers able to withstand the temperatures used to convert the ceramic precursor polymer to the ceramic material. The felts may include a minor amount of other refractory fibers. Suitable examples of other refractory fibers include, without limitation, alumina silicate fibers (typified by the Nextel™ family of fibers manufactured by 3M) and silicon carbide fibers (typified by Nicalon™ fibers manufactured by Nippon Industries).

In a preferred embodiment, the structural reinforcement system in the ceramic matrix composites is a dense felt mat containing graphite filaments. Graphite is desirable because it doesn't require an interfacial coating to prevent the ceramic matrix from adhering to it. Additionally, graphite conducts heat well, particularly along the length of the filament, which helps to minimize thermal gradients within the ceramic composite. Graphite also offers a cost advantage over other some of the other reinforcement systems that are useful for ceramic composites.

The high-density graphite, carbon, or graphite felt is used to make ceramic matrix composites in a manner similar to using refractory woven cloth is used in conventional processes to make composites. The composites may be produced by first impregnating the mats with a liquid preceramic mixture including a curable preceramic polymer and, if desired, fillers. This preceramic mixture can be formed by either a solution or melt route. In the solution route the curable preceramic polymer and fillers are mixed in an organic solvent. The preferred solvents are those with a low vaporization point (such as lower than about 125° C.) at atmospheric pressure to facilitate removal. Examples of suitable organic solvents include aliphatic hydrocarbons such as hexane, heptane etc. and aromatic hydrocarbons such as toluene. In the melt route, the curable preceramic polymer is heated to a temperature above its melting point yet below its curing temperature in an inert environment to form the preceramic mixture. Fillers may also be mixed in the molten polymer if desired.

In a preferred method, one felt piece or a number of felt pieces are cut to the desired shape and layered in a stack to the desired thickness. The felt pieces are then impregnated with an appropriate amount of ceramic precursor resin, preferably enough to completely fill the remaining desired part volume. The polymeric ceramic precursor can be used with or without a solvent, depending upon its viscosity. The stack is compressed sufficiently to assure intimate contact between the layers and achieve the desired part thickness. The part is next heated to polymerize or crosslink the resin (or, in the case of a polymer solution, to evaporate the solvent), then “fired” to convert the polymer to a ceramic.

Various ceramic precursor resins are known, many of which are commercially available. There are two main classes of ceramic precursor resin: one that is used to make oxide ceramics and a second that is used to make non-oxide ceramics. Oxide-type resins are heated in the presence of oxygen, whereas the non-oxide-type resins are heated in an oxygen-free atmosphere, for example in argon, nitrogen, hydrogen, or ammonia.

Ceramic forming resins include those resins which pyrolyze to form a solid phase (crystalline or amorphous) containing one or more of the following: silicon carbide, carbon, silicon nitride, silicon-oxycarbides, silicon-carbonitrides, boron carbide, boron nitride, and metal carbides or nitrides where the metal is typically zirconium or titanium. For example, and without limitation, the ceramic precursor resin may be a polysilazane, a polysiloxane, or a polycarbosilane, preferably a carbon-, aluminum oxide-, and/or boron-modified polysilazane or polysiloxane resin. Specific examples of precursor ceramic materials include, without limitation, those that produce a SiC ceramic, such as those described in Laine, et al., U.S. Pat. No. 6,133,396, incorporated herein by reference; polysiloxanes, such as those described in Choi, et al, U.S. Pat. No. 6,140,448; precursor materials that include a cyclosiloxane monomer, as disclosed in Leung et al., U.S. Pat. No. 5,231,059, 5,242,866, and 5,468,318, all of which are incorporated herein by reference, in which the polymerization reaction may be carried out in the presence of a hydrosilylation catalyst, e.g. platinum; the polymer precursors described in Leung et al., U.S. Pat. Nos. 5,455,208 and 5,438,025; Zupancic et al., U.S. Pat. No. 5,376,595, each of which is incorporated herein by reference. In one preferred embodiment, the precursor material used is one that produces an amorphous, carbon-modified silica, such as those commercially available from AlliedSignal, Morristown, N.J. under the trademark Blackglas.

The organopolysiloxane may also be substituted with various metallo groups (i.e., containing repeating metal—O—Si units). Examples of suitable compounds include borosiloxanes and alumosiloxanes. If the organosilicon polymer is an organopolysiloxane, it may contain units of general structure [R₃ SiO₅], [R₂ SiO], [RSiO_{1.5}], and [SiO₂] where each R is independently selected from the group consisting of hydrogen, alkyl radicals containing 1 to 20 carbon atoms such as methyl, ethyl, propyl etc., aryl radicals such as phenyl, and unsaturated alkyl radicals such as vinyl. Examples of specific organopolysiloxane groups include [PhSiO_{1.5}], [MeHSiO_{1.5}], [MePhSiO], [[Ph₂SiO], [PhSiO] ViSiO_{1.5}], [MeHSiO], [MeViSiO], [Me₂SiO], [Me₃SiO_{0.5}], and the like. Mixtures of organopolysiloxanes may also be employed.

The organopolysiloxanes of this invention can be prepared by techniques well known in the art. The actual method used to prepare the organopolysiloxanes is not critical. Most commonly, the organopolysiloxanes are prepared by the hydrolysis of organochlorosilanes.

Polysilazanes, having backbones with alternating silicon and nitrogen atoms, are also suitable as ceramic precursor resins. Examples of suitable polysilazanes include hydridosilazanes, vinyl modified polysilazanes, silacyclobutasilazanes, vinyl modified poly(disilyl)silazanes, and borosilazanes. Kaya et al., U.S. Pat. No. 5,459,114, the disclosure of which is incorporated herein by reference, describes a variety of polysilazane polymers that can be used alone or in any combination as the ceramic precursor resin. If the pre-ceramic organosilicon polymer is a polysilazane, it may contain units of the type [R₂SiNH] or [RSi(NH)_{1.5}] where each R is independently selected from the group consisting of hydrogen, alkyl radicals containing 1 to 20 carbon atoms such as methyl, ethyl, propyl etc., aryl radicals such as phenyl, and unsaturated hydrocarbon radicals such as vinyl. Examples of specific polysilazane units include [Ph₂ SiNH], [PhSi (NH)_{1.5}], [MeSi (NH)_{1.5}], [Me₂ SiNH], [ViSi (NH)_{1.5}], [Vi₂ SiNH], [PhMeSiNH], [HSi(NH)_{1.5}], [PhViSiNH], [MeViSiNH], and the like.

Polysilazanes can be prepared by techniques well known in the art. The actual method used to prepare the polysilazane is not critical. Suitable pre-ceramic silazane polymers or polysilazanes may be prepared by the methods of Gaul in U.S. Pat. No. 4,312,970 (issued Jan. 26, 1982), 4,340,619 (issued Jul. 20, 1982), U.S. Pat. No. 4,395,460 (issued Jul. 26, 1983), and 4,404,153 (issued Sep. 13, 1983), all of which are hereby incorporated by reference. Suitable polysilazanes also include those prepared by the methods of Haluska in U.S. Pat. No. 4,482,689 (issued Nov. 13, 1984) and Seyferth et al. in U.S. Pat. No. 4,397,828 (issued Aug. 9, 1983), both of which are hereby incorporated by reference. Other polysilazanes suitable for use in this invention can be prepared by the methods of Cannady in U.S. Pat. No. 4,540,803 (issued Sep. 10, 1985), U.S. Pat. No. 4,543,344 (issued Sep. 24, 1985), Burns et al. in J. Mater. Sci, 22 (1987), pp 2609-2614, and Burns in U.S. Pat. Nos. 4,835,238, 4,774,312, 4,929,742 and 4,916,200, which are all incorporated herein in their entirety. Schwark, U.S. Pat. No. 5,464,918 describes polysilazane containing chemically bound peroxide groups that may also be substituted by alkenyl or alkynyl groups for crosslinking. Bujalski et al, U.S. Pat. Nos. 5,262,553 and 5,364,920, the disclosures of which along with their cited and incorporated references are incorporated herein by reference, the disclosure of which is incorporated herein by reference, describes preparing a ceramic from a polysilazane polymer with a silazane crossliner having boron functional groups. Mahone, U.S. Pat. No. 5,086,126 discloses a process for adding vinyl groups to a polysilazane such that upon addition of a free radical precursor the polymer would rapidly cure.

Other useful ceramic precursors include, without limitation, polysilanes, polycarbodisilanes, polyaluminoxanes, polyborosiloxanes, polysilastyrene, polycarboranesiloxane, oligomers of ladder polymers of polysilicones, polytitanocarbosilane, heptamethylvinyltrisilane, polyborodiphenylsiloxane and boronylpyridine. In a preferred embodiment, the ceramic precursor is selected from polysilazanes and polysiloxanes.

If the pre-ceramic organosilicon polymer is a polysilane, it may contain units of general structure [R₃ Si], [R₂Si], and [RSi] where each R is independently selected from the group consisting of hydrogen, alkyl radicals containing 1 to 20 carbon atoms such as methyl, ethyl, propyl etc., aryl radicals such as phenyl, and unsaturated hydrocarbon radicals such as vinyl. Examples of specific polysilane units are [Me₂ Si], [PhMeSi], [MeSi], [PhSi], [ViSi], [PhMeSi], [MeHSi], [MeViSi], [Ph₂Si], [Me₃Si], and the like.

Polysilanes can be prepared by techniques well known in the art. The actual method used to prepare the polysilanes is not critical. Suitable polysilanes may be prepared by the reaction of organohalosilanes with alkali metals as described in Noll, Chemistry and Technology of Silicones, 347-49 (translated 2d Ger. Ed., Academic Press, 1968). More specifically, suitable polysilanes may be prepared by the sodium metal reduction of organo-substituted chlorosilanes as described by West in U.S. Pat. No. 4,260,780 and West et al. in 25 Polym. Preprints 4 (1984), both of which are incorporated by reference. Other suitable polysilanes can be prepared by the general procedures described in Baney, et al., U.S. Pat. No. 4,298,559 which is incorporated by reference.

The polysilane may also be substituted with various metal groups (i.e., containing repeating metal-Si units). Examples of suitable metals to be included therein include boron, aluminum, chromium and titanium. The method used to prepare said polymetallosilanes is not critical. It may be, for example, the method of Chandra et al. in U.S. Pat. No. 4,762,895 or Burns et al. in U.S. Pat. No. 4,906,710, both of which are incorporated by reference.

If the preceramic organosilicon polymer is a polycarbosilane, it may contain units of the type [R₂ SiC], [RSiC_{1.5}], and/or [R₃ SiC] where each R is independently selected from the group consisting of hydrogen, alkyl radicals containing 1 to 20 carbon atoms such as methyl, ethyl, propyl etc., aryl radicals such as phenyl, and unsaturated hydrocarbon radicals such as vinyl. Suitable polymers are described, for instance, by Yajima et al. in U.S. Pat. Nos. 4,052,430 and 4,100,233, both of which are incorporated herein in their entirety. Polycarbosilanes containing repeating (—SiHCH₃—CH₂—) units can be purchased commercially from the Nippon Carbon Co.

The polycarbosilane may also be substituted with various metal groups such as boron, aluminum, chromium and titanium. The method used to prepare such polymers is not critical. It may be, for example, the method of Yajima et al. in U.S. Pat. Nos. 4,248,814, 4,283,376 and 4,220,600.

The above organosilicon polymers which contain vinyl groups may be preferred since vinyl groups attached to silicon provide a mechanism whereby the organosilicon polymer can be cured prior to sintering. Also, mixtures of any of the above organosilicon compounds are also contemplated by this invention.

Silicon carbide ceramics may also be prepared from the polymeric precursors described in Whitmarsh et al., U.S. Pat. No. 5,153,295, the disclosure of which is incorporated herein by reference.

Polyborosilazane ceramic precursors are described in Funayama, et al., U.S. Pat. No. 5,030,744, the disclosure of which is incorporated herein by reference.

Block copolymers may also be used, for example a thermosetting copolymer comprising a perhydropolysilazane or polyborosilazane block A and a thermoplastic silicon-containing polymer block B as described in Funayama et al, U.S. Pat. No. 5,292,830, incorporated herein by reference.

Polymetalosilazanes and their synthesis are described, for example, in Shimizu et al., U.S. Pat. No. 5,436,398, incorporated herein by reference.

The ceramic precursor material may be mixed with a discontinuous or particulate reinforcement material before being impregnated into the high density carbon or graphite mat.

When the high density carbon or graphite mat is impregnated with a ceramic precursor material, i.e. with unpolymerized material, the ceramic precursor material is polymerized after impregnation to form a ceramic precursor polymer. The ceramic precursor polymer is then converted to a ceramic. Typically, the part is heated to from about 600° C. to about 1200° C. to undergo conversion to the ceramic material. The preferred conversion temperature and conditions depend upon the particular ceramic precursor polymer selected.

Because conversion of the ceramic precursor polymer to the ceramic results in a weight loss and formation of voids, the ceramic article may be densified by re-impregnation with the ceramic precursor material or polymer and conversion of the newly-introduced ceramic precursor to ceramic. The densification step may be repeated until the desired density of the ceramic article is obtained.

Fabrication of a simple ceramic composite part according to a preferred embodiment consists of three parts: converting rayon felt into high density graphite felt, forming the ceramic part, and densifying the ceramic.

The first part of the process is the conversion of rayon felt into graphite felt. A suitable quantity of rayon felt having the desired filament length is moistened with water. Pressure is applied to obtain the desired amount of compression. The rayon felt is then allowed to dry. The dried rayon felt is then exposed to sufficient heat for a sufficient duration in a non-oxidizing atmosphere to convert the rayon filaments into graphite filaments.

The second part of the process is forming the ceramic part. The high-density graphite felt is cut into pieces having the preliminary part dimensions. A suitable number, enough to achieve the desired final part thickness, of the high-density graphite felt pieces are then layered into a stack. The stack is then impregnated with a ceramic precursor resin. Many ceramic precursor resins are commercially available. One preferred ceramic precursor resin is a siloxane-based polymer (polysiloxane), sold under the name Blackglas™ by Honeywell's Micro-Electronic Materials business unit. The required amount of the, unpolymerized, ceramic precursor resin, typically enough to completely fill the part volume when combined with the graphite felt, is used to saturate the layered graphite felt pieces. A sufficient pressure is applied to the layered stack to assure intimate contact between the layers. The ceramic precursor resin is then polymerized under suitable conditions, which in the case of a commercial resin may be suggested by the manufacturer of the ceramic precursor resin. After polymerization, the part is fired in a furnace or kiln, while completely immersed in an atmosphere devoid of oxygen to convert the polymerized resin to a ceramic.

The third, and final, part of the process is densifying the ceramic part. After firing, the part is removed from the furnace or kiln and allowed to cool to room temperature. When cool, the part is completely submerged in a bath of the ceramic precursor resin. A vacuum, preferably 29″ of Hg or greater, may aid in fully infiltrating the part with the resin. The ceramic precursor material may also be heated to reduce its viscosity during infiltrating the ceramic part. The reduced viscosity caused by heating the ceramic precursor materials also aids in more fully infiltrating the part with the precursor material. The infiltrated resin is polymerized and the part is fired as before to convert the precursor polymer to ceramic. The reinfiltration, polymerization, and conversion to ceramic steps are repeated until the desired ceramic density is achieved. In a preferred embodiment the density is at least about 0.2 grams per cubic centimeter, or a pore volume of less than about 10% of the total ceramic part volume.

Polysilazanes are used similarly, but have a slightly lower char yield after conversion. The ceramic composition varies depending upon the atmosphere: in argon, the product is amorphous silicon carbide, in ammonia the product is silicon nitride, in oxygen the product is SiOₓC, and so on.

In another embodiment of the invention, the densified carbon or graphite felts of the invention are used in a chemical vapor infiltration, or chemical vapor deposition, process to make a composite material. Such processes are well-known methods of depositing solid matrix material onto a reinforcment. It is preferred for carbon or silicon carbide to be the material that is vapor-deposited onto the densified felt.

The invention has been described in detail with reference to preferred embodiments thereof. It should be understood, however, that variations and modifications can be made within the spirit and scope of the invention.

What is claimed is:

1. A method for forming a ceramic composite, comprising steps of:
(a) providing at least one felt mat of carbon or graphite, the felt mat having a density of at least about 15% fiber volume based on total volume;
(b) wetting the felt mat with a ceramic precursor material;
(c) polymerizing the precursor material to form a ceramic precursor polymer; and
(d) converting the ceramic precursor polymer to a ceramic to form a ceramic reinforced with the felt.

2. A method according to claim 1, wherein the felt has a density of at least about 20% fiber volume based on total volume.

3. A method according to claim 1, wherein the felt has a density of at least about 25% fiber volume based on total volume.

4. A method according to claim 1, wherein the felt has a density of at least about 30% fiber volume based on total volume.

5. A method according to claim 1, wherein the felt has a density of at least about 35% fiber volume based on total volume.

6. A method according to claim 1, wherein the felt has a density of at least about 40% fiber volume based on total volume.

7. A method according to claim 1, wherein the ceramic is an amorphous, carbon-modified silica.

8. A method according to claim 1, wherein the ceramic precursor polymer is a polysiloxane.

9. A method according to claim 1, wherein the felt mat contains additional refractory filaments or particles.

10. A method according to claim 9, wherein the additional refractory filaments are selected from the group consisting of fiberglass filaments, ceramic filaments, and combinations thereof.

11. A method according to claim 10, wherein the carbon filaments additional refractory filaments have an interfacial coating.

12. A method according to claim 1, wherein the felt mat has an average void volume of less than about 85%.

13. A method according to claim 1, wherein the filaments of the felt mat are substantially parallel to the mat face.

14. A method according to claim 1, wherein a plurality of felt mats are provided in a desired arrangement in step (a).

15. A method according to claim 1, wherein a plurality of felt mats are stacked in step (a).

16. A method according to claim 1, wherein the felt mat has graphite filaments.

17. A method according to claim 16, wherein the felt mat having at least about 15% by volume graphite filaments.

18. A method according to claim 1, wherein the ceramic precursor polymer is formed by the hydrosilation of methylvinyl siloxanes and methylhydrosiloxanes.

19. A method for forming a ceramic composite, comprising steps of:
(a) providing a rayon felt mat;
(b) wetting the rayon felt mat with water;
(c) compressing the wetted rayon felt mat to a desired density of fibers;
(d) drying the compressed rayon felt mat to produce a densified rayon felt mat;
(e) heating the densified rayon felt mat in a non-oxidizing atmosphere to produce a graphite or carbon felt mat;
(f) infiltrating the graphite or carbon felt mat with a ceramic precursor material;
(g) polymerizing the precursor material to form a ceramic precursor polymer; and
(h) converting the ceramic precursor polymer to a ceramic to form a ceramic reinforced with the densified graphic or carbon felt mat.

20. A method according to claim 19, wherein the ceramic has a fiber content of at least about 40% by volume.

21. A method according to claim 19, wherein a plurality of densified graphite or carbon mats are produced by steps (a) to (e) and layered, infiltrated in step (f), and then the layers pressed together before step (g).

22. A method according to claim 19, wherein the ceramic is an amorphous, carbon-modified silica.

23. A method according to claim 19, wherein the ceramic precursor polymer is a polysiloxane.

24. A method according to claim 19, wherein the ceramic precursor polymer is a polysilazane.

25. A method according to claim 19, wherein the felt mat has a density of at least about 15% fiber volume based on total volume.

26. A method according to claim 19, wherein the felt has a density of at least about 20% fiber volume based on total volume.

27. A method according to claim 19, wherein the felt has a density of at least about 25% fiber volume based on total volume.

28. A method according to claim 19, wherein the felt has a density of at least about 30% fiber volume based on total volume.

29. A method according to claim 19, wherein the felt has a density of at least about 35% fiber volume based on total volume.

30. A method according to claim 19, wherein the felt has a density of at least about 40% fiber volume based on total volume.

31. A method according to claim 19, wherein the filaments of the felt met substantially parallel to the mat face.

32. A method according to claim 19, wherein the felt mat has graphite filaments.

33. A method for producing a ceramic part, comprising steps of:
(a) wetting a rayon felt mat with water;
(b) compressing the wetted rayon felt mat;
(c) drying the compressed rayon felt mat to produce a densified rayon felt mat;
(d) producing a graphite felt mat from the densified rayon felt mat;
(e) cutting the graphite felt mat to a cut mat having desired dimensions;
(f) layering a plurality of the cut graphite felt mats;
(g) wetting the graphite felt mat with a ceramic precursor material;
(h) pressing the wetted mats together;
(i) polymerizing the precursor material to form a ceramic precursor polymer; and
(j) converting the ceramic precursor polymer to a ceramic to form a ceramic part reinforced with the graphic felt mats.

34. A method according to claim 33, further comprising steps of (k) infiltrating the ceramic part with additional ceramic precursor material;
(I) reacting the precursor material to form a ceramic precursor polymer; and
(m) converting the ceramic precursor polymer to a ceramic.

35. A method according to claim 34, wherein steps (k), (I), and (m) are repeated until the ceramic part has a desired density.

36. A method according to claim 35, wherein the desired density is at least about 2 grams per cubic centimeter.

37. A method according to claim 34, wherein steps (k), (I), and (m) are repeated until the ceramic part has an average pore volume of less than about 10% of the total volume.

38. A method according to claim 34, further comprising a surface finishing step.

39. A ceramic composite formed according to the method of claim 1.

40. A ceramic composite formed according to the method of claim 19.

41. A ceramic composite formed according to the method of claim 33.

42. A method for making a dense carbon or graphite felt, comprising (a) wetting a rayon felt mat with water;
(b) compressing the wetted rayon felt mat;
(c) drying the compressed rayon felt mat to produce a densified rayon felt mat;
(d) heating the densified rayon felt mat to carbonize the rayon.

43. A method according to claim 42, wherein the densified rayon felt mat has at least about 35% fiber by volume.

44. A method according to claim 42, wherein the densified rayon felt mat has at least about 55% fiber by volume.

45. A method according to claim 42, wherein the densified rayon felt mat has at least about 80% fiber by volume.

46. A method according to claim 42, wherein the densified rayon felt mat is carbonized to a carbon felt mat.

47. A method according to claim 46, wherein the carbon felt mat has a density of at least about 40% by volume fiber.

48. A method according to claim 42, wherein the densified rayon felt mat is carbonized to a graphite felt mat.

49. A method according to claim 48, wherein the graphite felt mat has a density of at least about 40% fiber by volume.

50. A method according to claim 34, wherein the additional ceramic precursor material is heated in step (k) to reduce its viscosity during infiltrating the ceramic part.

51. A method for making a composite material, comprising:
(a) providing a dense carbon or graphite felt according to claim 42;
(b) subjecting the felt to chemical vapor deposition of a solid material.
